(19) United States
(12) Patent Application Publication
(10) Pub. No.: US 2011/0165115 A1
(43) Pub. Date: Jul. 7, 2011

(54) SYNERGISTIC ATTRACTANTS FOR PESTIFEROUS SOCIAL INSECTS

(75) Inventors: Qing-He Zhang, Spokane Valley, WA (US); Armenak Margaryan, Spokane Valley, WA (US)

(73) Assignee: STERLING INTERNATIONAL INC., Spokane, WA (US)

(21) Appl. No.: 12/948,322

(22) Filed: Nov. 17, 2010

Related U.S. Application Data
(60) Provisional application No. 61/292,726, filed on Jan. 6, 2010.

(51) Int. Cl. A01N 37/02; A01P 7/04; A01N 31/02

(52) U.S. Cl. 424/84

(57) ABSTRACT

An insect attractant composition is disclosed. The composition includes a volatile insect attractant chemical blend comprising acetic acid and one or more compounds selected from the short chain alcohol group chosen from among methyl-1-butanol, isobutanol, and 2-methyl-2-propanol; and one or more homo- or mono-terpene herbivore-induced plant volatiles chosen from among (E)-4,8-dimethyl-1,3,7-nonatriene, (Z)-4,8-dimethyl-1,3,7-nonatriene, 4,8,12-trimethyl-1,3E,7E,11-tridecatetraene, trans-β-ocimene, cis-β-ocimene, trans-α-ocimene, cis-α-ocimene, and any combination thereof. The composition may be useful to attract one or more insect species, including, but not limited to, wasps, hornets, and yellowjackets, to a location or trap.

### CROSS-REFERENCE TO RELATED APPLICATION

This application claims the benefit of U.S. Provisional Application No. 61/292,726, filed on Jan. 6, 2010, which is fully incorporated herein expressly by reference.

### BACKGROUND

Eusocial vespid wasps include several subfamilies such as Polistinae and Vespinae from Vespidae (Hymenoptera: Vespoidea); they are commonly referred to as paper wasps, yellowjackets, and hornets in North America. Ecologically speaking, paper wasps, yellowjackets and hornets are beneficial insects because they prey upon many pest insects that feed on agricultural crops, garden plants, and forests, especially during early and mid summer season. However, because of their stinging ability and propensity to nest in or near residential and recreational areas, they can be very hazardous to people and animals. The most frequently encountered hazard is that posed by vespid wasp foragers at picnic foods, beverage cans, and garbage containers, especially the several scavenging Vespula species. In recent years, paper wasps have caused serious problems in fruit orchards and vineyards by biting the fruit and causing scarring, which results in price devaluation and at high populations even pose a significant danger to harvesters.

Traps baited with various attractants have been promoted and used for years as effective for monitoring or controlling yellowjackets. The compound 2,4-hexadienyl butyrate is powerfully attractive to V. pensylvanica. It has been shown that the simple saturated ester, heptyl butyrate, is as attractive to the Western yellowjacket as was 2,4-hexadienyl butyrate. Heptyl butyrate is to this day the best commercially available attractant for Western yellowjackets and members of V. rufa group. However, heptyl butyrate is ineffective for attraction of yellowjackets occurring in the Eastern United States and of any hornets and paper wasps. The first chemical blends specifically attractive to nuisance species of yellowjackets in the Eastern U.S. were reported to be (E)-2-hexenal (leaf aldehyde) combined with either linalool or α-terpineol to attract members of the V. vulgaris group, but this attraction is not nearly so powerful as is attraction of V. pensylvanica to heptyl butyrate. During the late 1990s and early 2000, it was reported that the combination of acetic acid and isobutanol (or its isomers) significantly attract several species of pestiferous yellowjackets including V. pensylvanica, V. vulgaris, V. germanica and V. maculifrons, and paper wasps (Vespinae: Polistes spp.). (See U.S. Pat. No. 6,083,498.) V. maculifrons workers and drones have been reported to be attracted to acetic acid/isobutanol. V. vidua (Saussure) (a member of the V. rufa species group) has been reported to be attracted to ethyl (E,Z)-2,4-decadienoate (the “pear ester”).

Our own research and others' have shown that combining heptyl butyrate and the acetic acid/isobutanol blend in the same trap (dry or wet) was strongly antagonistic on the attraction of both yellowjackets and paper wasps. In order to eliminate such significant antagonistic effect between two types of attractants, a novel trap design with two releasing and capturing chambers was invented. (See United States Patent Application Publication No. 2009/0151228). This trap has been proven to be very efficient for catching both V. vulgaris and V. rufa groups of yellowjackets, paper wasps, and hornets, and has been commercialized as a part of the Rescue® trapping system (www.rescue.com). Recently, the combination of (E)-2-hexenal, diethyl acetal/α-terpineol or linalool mixtures with an acetic acid/isobutanol blend has been reported to attract Eastern yellowjacket (V. maculifrons) workers.

Chopped dried apple or apple pomace can be used as supplementary lures for trapping wasps in the family Vespidae in combination with volatile chemical attractants, including heptyl butyrate, acetic acid and isobutanol (see U.S. Patent Application Publication No. 2008/0175813). The combination of heptyl/octyl butyrate(s) with certain plant volatiles (kairomones), including trans-2-hexenol and methyl salicylate, has been shown to attract yellowjackets (see U.S. Patent Application Publication No. 2009/0081154). It has been reported that orchids might mimic green leaf volatiles or honeybee alarm pheromone to attract vespid wasps for pollination.

With all the effort to discover a powerful attractant system for the vespid wasps, unfortunately none of the known attractants show significant attraction during the early to mid-summer season when the wasp workers are mainly foraging for live insect preys for their hungry larvae. Thus, there is a strong need for a stand-alone or synergistic attractant(s) to significantly attract the foraging workers (mainly for live preys) during early to mid-season when current known attractant systems are inactive or only weakly attractive.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

One embodiment of the present invention is an insect attractant composition. The attractant composition includes a volatile insect attractant comprising acetic acid and one or more short chain alcohols chosen from 2-methyl-1-butanol, isobutanol, and 2-methyl-2-propanol, or a combination thereof; and one or more homo- or mono-terpene herbivore-induced plant volatiles chosen from (E)-4,8-dimethyl-1,3,7-nonatriene, (Z)-4,8-dimethyl-1,3,7-nonatriene, 4,8,12-trimethyl-1,3E,7E,11-tridecatetraene, trans-β-ocimene, cis-β-ocimene, trans-α-ocimene, cis-α-ocimene, or a combination thereof.

In the insect attractant composition of the first embodiment, the homoterpene herbivore-induced plant volatile can be (E)-4,8-dimethyl-1,3,7-nonatriene, (Z)-4,8-dimethyl-1,3,7-nonatriene, or 4,8,12-trimethyl-1,3E,7E,11-tridecatetraene.

In the insect attractant composition of the first embodiment, the monoterpene herbivore-induced plant volatile can be trans-β-ocimene, cis-β-ocimene, trans-α-ocimene, or cis-α-ocimene.

In the attractant composition of the first embodiment, the volatile insect attractant can be 2-methyl-1-butanol, acetic acid, or a combination thereof.

In the insect attractant composition of the first embodiment, the homo- or mono-terpene herbivore-induced plant volatile can be produced synthetically.

In the insect attractant composition of the first embodiment, the homo- or mono-terpene herbivore-induced plant volatile can be produced from a plant.

In the insect attractant composition of the first embodiment, the homo- or mono-terpene herbivore-induced plant volatile can be produced from plants, such as cherry, maize, cabbage, tomato, cucumber, and peas.

A second embodiment of the present invention is a trap that includes any one of the attractant compositions of the first embodiment. The trap may include one or more chambers into which insects find their way in but are incapable of escaping. The trap includes the attractant composition and allows for volatilization of the attractant composition to attract insects within the trap chamber.

A third embodiment of the present invention is a method of attracting an insect. The method includes releasing an attractant for an insect and a homo- or mono-terpene herbivore-induced plant volatile chosen from (E)-4,8-dimethyl-1,3,7-nonatriene, (Z)-4,8-dimethyl-1,3,7-nonatriene, 4,8,12-trimethyl-1,3E,7E,11-tridecatetraene, trans-β-ocimene, cis-β-ocimene, trans-α-ocimene, cis-α-ocimene, or a combination thereof; and attracting one or more insects to the volatized attractant and the homo- or mono-terpene herbivore-induced plant volatile. The attractant and the homo- or mono-terpene herbivore-induced plant volatile may volatize directly into the air.

The third embodiment may further include attracting an eusocial insect.

The third embodiment may further include attracting any insect that belongs to the order Hymenoptera.

The third embodiment may further include attracting any insect that belongs to the family Vespidae in the order Hymenoptera.

The third embodiment may further include attracting any insect that belongs to the subfamilies of Polistinae or Vespinae in the order Hymenoptera.

The third embodiment may further include attracting any insect that is a wasp, hornet, or yellowjacket.

The third embodiment may further include attracting any insect that belongs to the order Neuroptera.

The third embodiment may further include attracting any insect that belongs to the family Chrysopidae in the order Neuroptera.

The third embodiment may further include attracting a green lacewing.

The third embodiment may further include attracting any insect that belongs to the family Hermerobiidae in the order Neuroptera.

The third embodiment may further include attracting a brown lacewing.

The third embodiment may further include attracting any insect that belongs to the family Myrmeleonitidae in the order Neuroptera.

The third embodiment may further include attracting an ant lion.

The third embodiment may further include attracting any insect that belongs to the order Coleoptera.

The third embodiment may further include attracting any insect that belongs to the family Coccinellidae in the order Coleoptera.

The third embodiment may further include attracting a lady beetle.

The third embodiment may further include attracting any insect that belongs to the order Heteroptera.

The third embodiment may further include attracting any insect that belongs to the family Pentatomidae in the order Heteroptera.

The third embodiment may further include attracting a spined soldier bug.

The third embodiment may further include attracting any insect that belongs to the order Diptera.

The third embodiment may further include attracting any insect that belongs to the family Syrphidae in the order Diptera.

The third embodiment may further include attracting a hover fly.

The third embodiment may further include an attractant that is derived from a sugar.

The third embodiment may further include placing the attractant and the homo- or mono-terpene herbivore-induced plant volatile within a trap and attracting an insect to the inside of the trap.

The third embodiment may include a homoterpene herbivore-induced plant volatile that is (E)-4,8-dimethyl-1,3,7-nonatriene, (Z)-4,8-dimethyl-1,3,7-nonatriene, 4,8,12-trimethyl-1,3E,7E,11-tridecatetraene or a combination thereof.

The third embodiment may include a monoterpene herbivore-induced plant volatile that is trans-β-ocimene, cis-β-ocimene, trans-α-ocimene or cis-α-ocimene.

The third embodiment may include an attractant that is acetic acid.

The third embodiment may include an attractant that is 2-methyl-1-butanol.

The third embodiment may include an attractant that is isobutanol or 2-methyl-2-propanol.

The third embodiment may include a homo- or mono-terpene herbivore-induced plant volatile that is produced synthetically.

The third embodiment may include a homo- or mono-terpene herbivore-induced plant volatile that is produced from a plant.

The third embodiment may include attracting an insect from any one of the following species, Vespula pensylvanica, Vespula vulgaris, Vespula germanica, Vespula maculifrons, Vespula sqamosa, Vespula atropilosa, Vespula acadica, Vespula consobrina, Vespula vidua, Dolichovespula maculata, Dolichovespula arenaria, Vespa crabo, Polistes dominulus, Polistes aurifer, Polistes fuscatus, Polistes metricus, Polistes carolina, Polistes perplexus, Chrysopa oculata, Myrmeleon crudelis, Podisus maculiventris, Hippodamia convergens.

The third embodiment may include attracting any of the following insects: Western yellowjacket, German wasp, common wasp, Eastern yellowjacket, Southern yellowjacket, bald-faced hornet, aerial yellowjacket, prairie yellowjacket, forest yellowjacket, blackjacket, Northeastern yellowjacket, European hornet, European paper wasp, golden paper wasp, paper wasp, red wasp, green lacewing, ant lion, spined soldier bug, and lady beetle.

A fourth embodiment in accordance with the present invention is an insect attractant composition that consists essentially of a volatile insect attractant chemical blend comprising acetic acid and one or more compounds chosen from 2-methyl-1-butanol, isobutanol, and 2-methyl-2-propanol, or a combination thereof; and one or more homo- or mono-terpene herbivore-induced plant volatiles chosen from (E)-4,8-dimethyl-1,3,7-nonatriene, (Z)-4,8-dimethyl-1,3,7-nonatriene, 4,8,12-trimethyl-1,3E,7E,11-tridecatetraene, trans-β-ocimene, cis-β-ocimene, trans-α-ocimene, cis-α-ocimene, or a combination thereof, wherein there are no additional attractants in the composition.

A fifth embodiment in accordance with the present invention is an insect attractant composition consisting of water; acetic acid; one or more attractant compounds chosen from 2-methyl-1-butanol, isobutanol, and 2-methyl-2-propanol, or a combination thereof; and one or more homo- or mono-terpene herbivore-induced plant volatiles chosen from (E)-4,8-dimethyl-1,3,7-nonatriene, (Z)-4,8-dimethyl-1,3,7-nonatriene, 4,8,12-trimethyl-1,3E,7E,11-tridecatetraene, trans-β-ocimene, cis-β-ocimene, trans-α-ocimene, cis-α-ocimene, or a combination thereof, wherein the composition does not include any additional attractants.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A and 1B are graphs showing GC-EAD response of Polistes dominulus worker antennae to aeration samples of severely damaged (A) and undamaged or slightly damaged (B) cherry branches;

FIG. 2 is a graph showing GC-EAD response of Polistes dominulus worker antennae to a synthetic mixture of several common herbivore induced plant volatile (HIPV) candidates (100 ng/μl each in hexane);

FIG. 3 is a bar graph showing the number of captures of the yellowjacket and paper wasp workers in Rescue® W•H•Y traps baited with the W•H•Y (wasp, hornet, yellowjacket) attractants (AA/2MB from top chamber and HB from bottom chamber) alone, and the W•H•Y attractants plus individual HIPV candidates added to the top chamber (means within each species group followed by the same letter are not significantly different (P>0.05) by Duncan's multiple range test after ANOVA on the arcsin√P transformed data of the relative catches, i.e., proportion (P) of total captured wasps within each replicate);

FIG. 4 is a bar graph showing the number of captures of the yellowjacket and paper wasp workers in Rescue® W•H•Y traps baited with the W•H•Y top attractants (AA/2MB from top chamber) alone, and the W•H•Y top attractants plus different doses of an EAD-active HIPV, (E)-4,8-dimethyl-1,3,7-nonatriene, added to top chamber; (means within each species group followed by the same letter are not significantly different (P>0.05) by Duncan's multiple range test after ANOVA on the arcsin√P transformed data of the relative catches, i.e., proportion (P) of total captured wasps within each replicate);

FIG. 5 is a bar graph showing the number of captures of the yellowjacket and paper wasp workers in Rescue® W•H•Y traps baited either with the W•H•Y top attractants (AA/2MB from top chamber) or with different doses of (E)-4,8-dimethyl-1,3,7-nonatriene alone in the top chamber; (means within each species group followed by the same letter are not significantly different (P>0.05) by Duncan's multiple range test after ANOVA on the arcsin√P transformed data of the relative catches, i.e., proportion (P) of total captured wasps within each replicate); and

FIG. 6 is a graph showing GC-EAD antennal responses of beneficial insects: Chrysopa oculata, Myrmeleon crudelis, Podisus maculiventris, Hippodamia convergens, to several compounds.

### DETAILED DESCRIPTION

Disclosed is an attractant composition and a method of attracting one or more insects. The insect attractant composition can include one or more volatile homo- or mono-terpene herbivore induced plant volatiles (HIPVs) combined with an insect attractant or with another homo- or mono-terpene herbivore induced plant volatile. Representative homo- or mono-terpene herbivore induced plant volatiles include, but are not limited to: (E)-4,8-dimethyl-1,3,7-nonatriene, (Z)-4,8-dimethyl-1,3,7-nonatriene, 4,8,12-trimethyl-1,3E,7E,11-tridecatetraene, or any analogs thereof, trans-β-ocimene, cis-β-ocimene, trans-α-ocimene, cis-α-ocimene, or any analogs thereof. As used herein, the above listed HIPVs can be compounds that are produced in nature and used in a purified form or compounds that can be produced synthetically. The one or more homo- or mono-terpene herbivore induced plant volatiles may be combined with one or more volatile insect attractant chemicals. The homo- or mono-terpene herbivore induced plant volatiles may behave as synergists when combined with one or more other attractant chemicals. Suitable attractant chemicals to be used in the attractant composition include blends of acetic acid (AA) and one or more compounds selected from short chain alcohols including, but not limited to 2-methyl-1-butanol (2MB), isobutanol, and 2-methyl-2-propanol. Additionally, well known attractants including 2,4-hexadienyl butyrate, heptyl butyrate (HB), (E)-2-hexenal, linalool, α-terpineol, and (E,Z)-2,4-decadienoate may be used in the attractant composition. Natural attractants, such as apple juice, sugar-related foods and drinks, including pop drinks, and protein-related foods may be used in the attractant composition.

Homo- and mono-terpenes, especially (E)-4,8-dimethyl-1,3,7-nonatriene, (E)-β-ocimene and their isomers or analogs are herbivore-induced plant volatiles. Disclosed herein is the discovery that the antennae of insects, including, but not limited to, vespid worker insects, do have olfactory receptor neurons for detecting HIPVs as shown through GC-EAD analysis. The HIPVs that elicited a response include those that are released as major components from severely damaged plants including, but not limited to, cherry tree branches (Prunus avium ‘Lapins’). Other possible sources of the homo-, and mono-terpene HIPVs include, but are not limited to, maize, cabbage, tomato, cucumber, and peas that produce HIPVs after insect feeding. Field trapping bioassays revealed that (E)-4,8-dimenthyl-1,3,7-nonatriene and β-ocimene (from cherry trees or otherwise) significantly synergize the attraction of food-related attractants, such as mixtures comprising acetic acid (AA) and one or short chain alcohols chosen from among 2-methyl-1-butanol (2MB), isobutanol, and 2-methyl-2-propanol, to insects, such as vespid social wasps including paper wasps, yellowjackets, and hornets.

The attractant compositions can be used to attract one or more insects chosen from various insect orders, families, subfamilies, and species. Insects that may be attracted include insects from one or more insect orders chosen from Hymenoptera, Neuroptera, Coleoptera, Heteroptera, Diptera. Within Hymenoptera, the insects from Vespidae, Polistinae and Vespinae families may be attracted. Insects from the order Hymenoptera include, but are not limited to wasps, hornets, and yellowjackets. Within Neuroptera, the insects from the Chrysopidae, Hermerobiidae, Myrmeleonitidae families may be attracted. Insects from the order Neuroptera include, but are not limited to, green lacewings, brown lacewings, and ant lions. Within Coleoptera, the insects from the Coccinellidae family may be attracted, including insects such as lady beetles. Within Heteroptera, the insects from the Pentatomidae family may be attracted, including insects such as the spined soldier bug. Within Diptera, insects from the Syrphidae family may be attracted, including insects such as the hover fly. The attractant compositions disclosed herein may be used to attract to a location any one or more of the following insects, Vespula pensylvanica (western yellowjacket), Vespula germanica (German yellowjacket), Vespula vulgaris (common wasp), Vespula maculifrons (Eastern yellowjacket), Vespula sqamosa (Southern yellowjacket), Dolichovespula maculata (bald-faced hornet), Dolichovespula arenaria (aerial yellowjacket), Vespula atropilosa (prairie yellowjacket). Vespula acadica (forest yellowjacket), Vespula consobrina (blackjacket), Vespula vidua (Northeastern yellowjacket), Vespa crabo (European hornet), Polistes dominulus (European paper wasp), Polistes aurifer (golden paper wasp), Polistes fuscatus (paper wasp), Polistes metricus (paper wasp), Polistes carolina (red wasp), Polistes perplexus (red wasp), Chrysopa oculata (green lacewing), Myrmeleon crudelis (ant lion), Podisus maculiventris (spined soldier bug), Hippodamia convergens (lady beetle).

The attractant composition disclosed here has a plurality of uses. In one embodiment, the attractant composition may be placed within a trap. Representative traps include those that attract insects into a chamber from which insects cannot escape. Representative traps include, but are not limited to, the traps disclosed in U.S. Pat. Nos. 5,557,880; 7,412,797; and U.S. Patent Application Publication Nos. 2008/0263939 and 2009/0151228. All these patents and applications are incorporated herein expressly by reference. A suitable trap may include a holder within which to place the attractant composition. The attractant composition can be in liquid or solid form or a combination of liquids and solids. However, a gaseous delivery device may also be used. In one embodiment, a liquid attractant composition may be impregnated onto a porous absorbent material. In another embodiment, the attractant composition may be impregnated in or combined with a polymer substrate. The attractant composition is manufactured to be volatile so as to release an effective amount of volatized attractant composition from the trap. To this end, the trap may provide ports to allow the attractant composition vapors to leave the trap. The trap may provide a means to reduce or control the amount of volatized attractant composition that leaves the trap. In one embodiment, the means to control the escape of the vaporized composition may include a plurality of openings that can be closed, such as by sliding a lid over the openings. The highest concentration of vaporized attractant composition can accumulate within the trap, so as to draw insects inside of the trap. The trap may provide an entry for insects. The entry may lead to a chamber. The trap may be designed with an entry that is easy to get in but difficult for insects to find a way out. In one embodiment, the entry to the chamber can be designed as a funnel with a larger opening leading to a small opening slightly larger than the insect to allow the insect to enter the chamber.

Another use of the attractant composition is to attract beneficial insects. For example, some insects are known to prey on harmful insects. Lady beetles, for example, can prey on aphids, mites, mealybugs, thrips, and scale. Other beneficial insects that may be attracted include, but are not limited to, ant lions and their larva, green lacewings, brown lacewings, hover flies, and the spined soldier bug. In one embodiment, a suitable amount of attractant composition may be delivered in or to an area infested with harmful insects. The attractant composition causes the beneficial insects to come to the area with the attractant composition. Once in the area, the beneficial insects may prey on the harmful insects to relieve the area of the harmful insects. Such use may include spraying or applying the attractant composition in and around ornamental plants or fruit or vegetable-bearing plants. The attractant composition provides for nontoxic control of harmful insect pests.

As mentioned above, paper wasps, yellowjackets, and hornets not only pose a significant stinging hazard to humans, but also are efficient generalist predators in nature. It is not yet known what exact kinds of chemical signals the paper wasp, yellowjacket, and hornet workers use to find their live insect preys on the plants for feeding their larvae in the nests. However, the so-called “herbivore-induced plant volatiles” (HIPVs) released specially from plants that are attacked by herbivores might provide detectable and reliable chemical information of potential herbivore prey presence and identity for the vespid wasp workers. Over the past 20 years, the chemical ecology on HIPVs as one of the most active and exciting research fields has made significant progress, and has revealed great potential for developing effective and practical semiochemical-based strategies for manipulating natural enemy populations in the crop pest management. The induction of HIPVs has been investigated for many plant-arthropod interactions, and production/release of HIPVs has been reported for all the plant species studied so far. Moreover, all the herbivore species investigated, including spider mites, folivorous and stem-boring caterpillars, aphids, scale insects, psyllids, root-feeding beetles and folivorous beetles, induce the HIPVs. These HIPVs include monoterpenes and sesquiterpenes [e.g., trans-β-ocimene, (E)-4,8-dimethyl-1,3,7-nonatriene (DMNT), TMTT (4,8,12-trimethyl-1,3E,7E,11-tridecatetraene), and farnesene] from the isoprenoid pathway, green leaf volatiles (e.g., cis-3-hexen-1-ol, trans-2-hexen-1-ol and cis-3-hexenyl acetate) from the fatty acid/lipoxygenase pathway, products of the octadecanoid pathway, and aromatic metabolites of the shikimate, tryptophan and phenylalanoic ammonia lyase pathways (e.g., indole and methyl salicylate). Recently, synthetic HIPVs have been used to either attract predators and parasitoids or to induce plants to produce their own HIPVs in the field experiments.

The following examples were undertaken to: (1) understand if the antennae of insects, including vespid wasps, and several major beneficial insects, are able to detect the HIPVs from natural samples (damaged and undamaged cherry branches) or synthetic mixtures using Gas Chromatography-ElectroAntennographic Detection (GC-EAD) technique; and (2) to determine if the EAD-active synthetic HIPVs alone or in combination with known attractants would be attractive or synergistically attractive to the workers of paper wasps, yellowjackets, and hornets, especially during the live prey foraging seasons.

### Examples

### Materials and Methods

Aerations of Undamaged and Damaged Cherry Branches.

Lapin cherry branches with severely damaged cherries and leaves and undamaged or slightly damaged branches were collected from a cherry orchard at Creston, Canada, on Jul. 29, 2009, and were transported to the Sterling International, Inc. lab (Spokane, Wash.) on the same day and kept at 4° C. before aerations. Headspace volatiles from the cherry branches (damaged or undamaged) were sampled by a battery operated pump and a high density polyacetate oven bag (48.2×59.6 cm Reynolds® Oven Bag; Richmond, Va., USA) enclosure with one activated charcoal filter tube in the air inlet, on Jul. 30, 2009. The volatiles in the enclosure were trapped on one Porapak Q tube (50/80 mesh; 30 mg in Teflon tube: 3 mm×35 mm) for 2.5 hr (airflow 300 ml/min) and extracted with 1 ml redistilled pentane.

GC-EAD/MS Analysis.

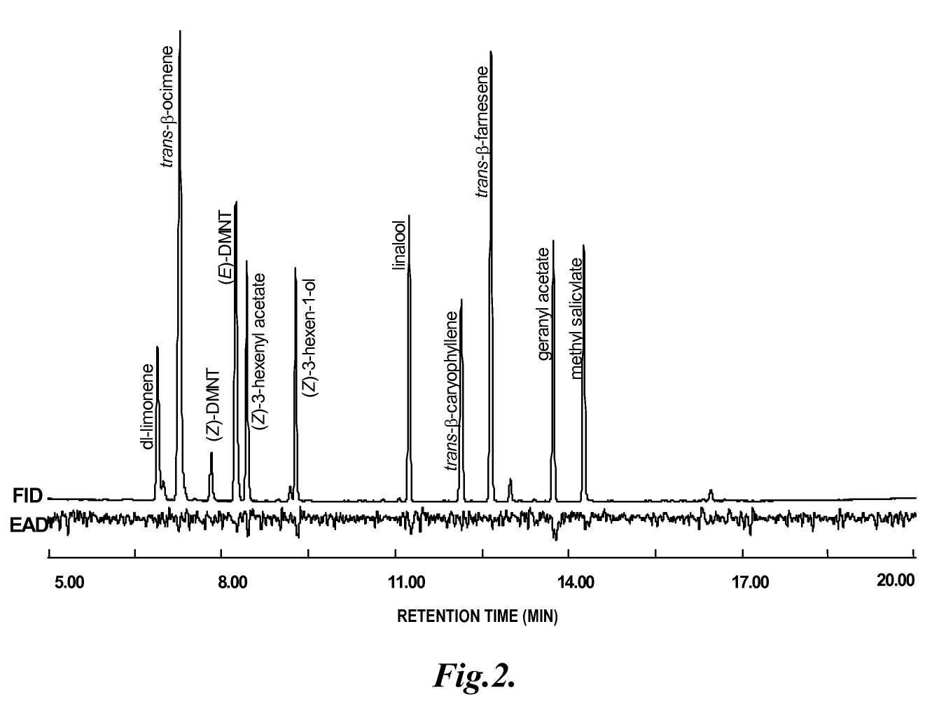

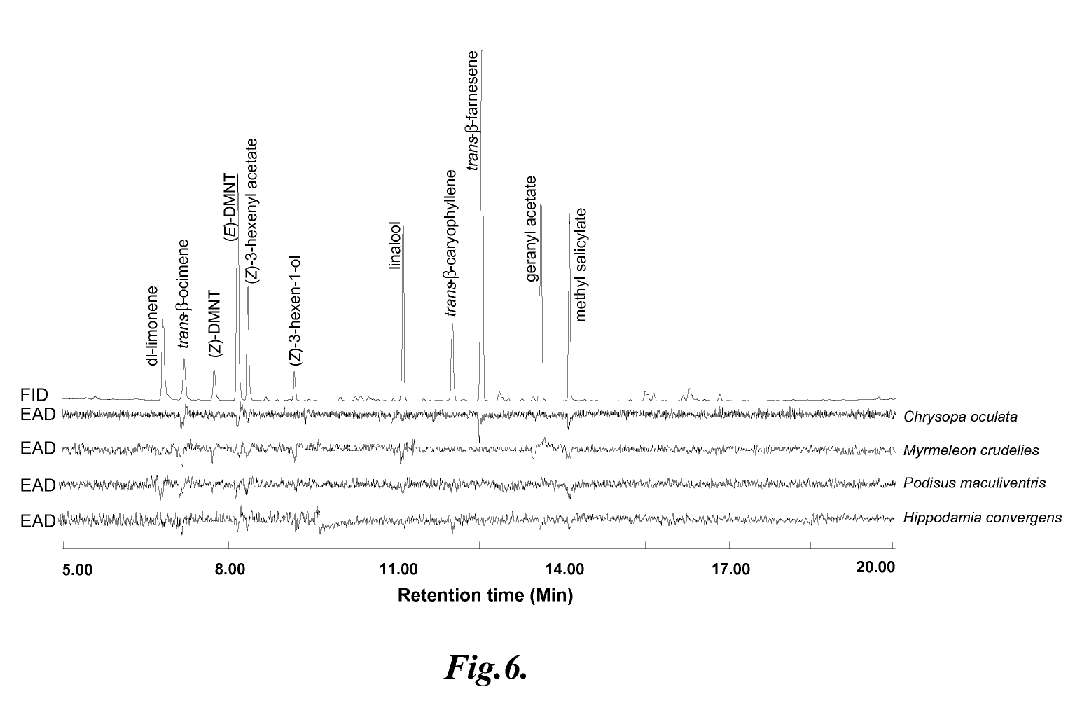

Aeration samples of the cherry branches (damaged or undamaged/slightly damaged) were injected (3 μl) splitless into a Varian CP-3800 GC equipped with a polar column (HP-INNOWax; 30 m×0.53 mm×1.0 μm film thickness; Agilent Technologies, Wilmington, Del., USA) and a 1:1 effluent splitter that allowed simultaneous flame ionization detection (FID) and electroantennographic detection (EAD) of the European paper wasp (Polistes dominulus) worker antennae to the separated volatile compounds. Helium was used as the carrier gas, and the injector and detector temperatures were 250° C. and 300° C., respectively. Column temperature was 50° C. for 1 min, rising to 240° C. at 10° C./min, and then held for 10 min. The outlet for the EAD was held in a humidified air stream flowing at 0.5 m/sec over the antennal preparation. EAD recordings were made using silver wire-glass capillary electrodes filled with Beadle-Ephrussi Ringer on freshly cut antennae. The antennal signals were stored and analyzed on a PC equipped with a serial IDAC interface box and the program EAD ver. 2.5 (Syntech, Hilversum, The Netherlands). In addition, GC-EAD responses to a synthetic mixture (100 ng/μl each) containing nine known HIPVs including cis-3-hexen-1-ol, cis-3-hexenyl acetate, trans-β-ocimene, (E)-4,8-dimethyl-1,3,7-nonatriene, linalool, methyl salicylate, geranyl acetate, trans-β-caryophyllene and trans-β-farnesene were tested on the P. dominulus workers. (See FIG. 2.) The same chemicals were also tested on beneficial insect antennae from Chrysopa oculata, Myrmeleon crudelis, Podisus maculiventris, and Hippodarnia convergens. (See FIG. 6.) Antennally active peaks in the aeration samples were identified by GC-MS on an HP 6890 GC series coupled with an HP 5973 Mass Selective Detector using the same type of GC column and conditions as described above. Compounds were identified by comparison of retention times with those of authentic standards and with mass spectra of standards.

Chemical Standards.

The following authentic chemical standards for chemical identification or field trapping were obtained from commercial sources or were synthesized: (E)-2-hexenal (95%), (Z)-3-hexen-1-ol (98%), (Z)-3-hexenyl acetate (98%), cis-ocimene (>75%, with ca. 20% limonene as impurity), linalool (97%), methyl salicylate (99%), geranyl acetate (98%) and trans-β-caryophyllene (80%, with ca. 20% of hummulene) were obtained from Sigma-Aldrich Chemical (Milwaukee, Wis.); trans-β-farnesene (90%) from Bedoukian Research Inc., Danbury, Conn. (E)-4,8-dimethyl-1,3,7-nonatriene (91%) was synthesized from geraniol via geranial as described by LEOPOLD, E. J. 1986, Selective hydroboration of a 1,3,7-triene: homogeraniol, Organic Syntheses 64:164.

Field Trapping Experiments.

Three field trapping experiments were carried out during late July to early August 2009, in residential and woody areas around Spokane, Wash., USA, using the newly marketed Rescue® W•H•Y traps (www.rescue.com). As used herein, the W•H•Y trap is a trap in accordance with the description of United States Patent Application Publication No. 2009/0151228. The W•H•Y trap has a top chamber and a bottom chamber. The top chamber is baited with two attractants—one of which is a solid contained in a vial (2-methyl-1-butanol) and the other a liquid mixed with water (acetic acid), herein referred to as the W•H•Y top attractant. The bottom chamber is baited with a liquid attractant (heptyl butyrate) poured onto a cotton pad, herein referred to as the W•H•Y bottom attractant. Separation of the top and bottom attractants (otherwise antagonistic to each other when released from the same chamber) in two chambers was a design feature of this trap and creates two focal attraction sources from one trap for different species of wasps, hornets, and yellowjackets. Traps were hung 1.5-2.0 m above the ground on either the fence or tree branches ca. 5 m apart within each trap line. For each trapping experiment, six sets of traps were deployed with their initial trap positions within each set being randomized. To minimize positional effects and obtain more replications, wasp collections and trap re-randomization were carried out when ≧10-20 wasps were caught in the best trap. Each replicate lasted several days depending on wasp flight activity. Captured wasps were removed from the traps and kept in the zip-bags before taking back to the laboratory for recording of the species, gender status, and catch.

Experiment 1 (Jul. 22-30, 2009) tested ten synthetic HIPV candidates [(E)-2-hexenal, (Z)-3-hexen-1-ol, (Z)-3-hexenyl acetate, cis-ocimene, linalool, methyl salicylate, geranyl acetate, trans-β-caryophyllene, trans-β-farnesene and (E)-4,8-dimethyl-1,3,7-nonatriene], including several paper wasp EAD-active compounds (see FIG. 2 for details), to determine their potential synergistic effect on the Rescue® W•H•Y trap attractants to paper wasps, yellowjackets, and hornets. Experiment 2 (Aug. 5-13, 2009) tested behavioral responses of the paper wasps and yellowjackets to the Rescue® W•H•Y trap attractants (top attractants only) and its combination with (E)-4,8-dimethyl-1,3,7-nonatriene, one of the EAD-active and behaviorally significant HIPVs, in a dose-response fashion. Experiment 3 (Aug. 5-13, 2009) was conducted to determine the potential behavioral activity of different doses of (E)-4,8-dimethyl-1,3,7-nonatriene alone. The individual (or different doses) HIPVs were loaded into either polyethylene bags or centrifuge tube type of dispensers, and released from the top of the W•H•Y trap chamber. W•H•Y trap attractants (both top and bottom or top only) alone and water (top chamber only) were included in the test as positive and blank controls, respectively. The dispenser types, loading and release rates of the tested semiochemicals are described in Tables 1, 2 and 3.

TABLE 1
(EXPERIMENT 1)

| HIPVs added to | Dispenser | | | | | | |
|---|---|---|---|---|---|---|---|
| WHY attractant | Release | | | Loading | Total Yellowjacket Catches | | |
| (in the top chamber) | Rate | Type | Size | μL | V. pensylvanica | V. vulgaris | D. maculata |
| Methyl Salicylate | 25 | 12 Mil PE | 3 cm × | 1500 | 226 | 23 | 1 |
| | | Bag | 5 cm | | | | |
| Z-3-Hexenyl | 20 | 12 Mil PE | 1.5 cm × | 1000 | 311 | 34 | 1 |
| Acetate | | Bag | 5 cm | | | | |
| Ocimene | 8 | VWR CFT | (2x) | 100 | 402 | 52 | 17 |
| | | | 1 mm | | | | |
| | | | Holes | | | | |
| (E)-4,8-dimethyl- | 1 | VWR CFT | 2 mm | 500 | 463 | 52 | 12 |
| 1,3,7-nonatriene | | | Hole | | | | |
| E-2-Hexenal | 30 | 12 Mil PE | 3 cm × | 1000 | 423 | 44 | 2 |
| | | Bag | 5 cm | | | | |
| Z-3-Hexanol | 20 | 2 Mil PE | 3 cm × | 600 | 288 | 33 | 5 |
| | | Bag | 5 cm | | | | |
| Linalool | 10 | 4 Mil PE | 3 cm × | 1000 | 291 | 32 | 1 |
| | | Bag | 5 cm | | | | |
| Geranyl Acetate | 15 | 6 Mil PE | 3 cm × | 1000 | 128 | 18 | 1 |
| | | Bag | 5 cm | | | | |
| β-Caryophyllene | 15 | 6 Mil PE | 2 cm × | 1000 | 234 | 51 | 0 |
| | | Bag | 5 cm | | | | |
| E-β-Farnesene | 5 | 6 Mil PE | 3 cm × | 100 | 321 | 36 | 8 |
| | | Bag | 5 cm | | | | |
| WHY Alone | | 6 Mil PE | 3 cm × | | 302 | 33 | 13 |
| | | Bag | 5 cm | | | | |
| Water Blank | | 6 Mil PE | 3 cm × | | 59 | 2 | 1 |
| control | | Bag | 5 cm | | | | |

| HIPVs added to | | | | | | |
|---|---|---|---|---|---|---|
| WHY attractant | Total Yellowjacket Catches | | | | Total Paper Wasps | |
| (in the top chamber) | D. arenaria | V. atropilosa | V. acadica | V. consobrina | P. dominulus | P. aurifer |
| Methyl Salicylate | 4 | 4 | 0 | 2 | 33 | 6 |
| Z-3-Hexenyl | 8 | 0 | 1 | 1 | 40 | 9 |
| Acetate | | | | | | |
| Ocimene | 11 | 2 | 0 | 0 | 29 | 17 |
| (E)-4,8-dimethyl- | 7 | 3 | 1 | 0 | 152 | 12 |
| 1,3,7-nonatriene | | | | | | |
| E-2-Hexenal | 4 | 3 | 0 | 0 | 19 | 8 |
| Z-3-Hexanol | 1 | 0 | 0 | 0 | 25 | 4 |
| Linalool | 0 | 0 | 0 | 0 | 46 | 13 |
| Geranyl Acetate | 2 | 2 | 0 | 1 | 13 | 4 |
| β-Caryophyllene | 5 | 1 | 2 | 1 | 35 | 12 |
| E-β-Farnesene | 10 | 1 | 0 | 0 | 29 | 13 |
| WHY Alone | 6 | 2 | 1 | 0 | 21 | 10 |
| Water Blank | 3 | 4 | 0 | 0 | 15 | 4 |
| control | | | | | | |

TABLE 2
(EXPERIMENT 2)

| DMNT added to | 2 mL VWR Centrifuge Tube | | | | | | | | |
|---|---|---|---|---|---|---|---|---|---|
| WHY attractant | with Cotton | | | | | | | Total Paper Wasps | |
| (in the top | Release | Hole | Loading | Total Yellowjackets Caught | | | | Caught | |
| chamber) | Rate | Size mm | μL | V. pensylvanica | V. vulgaris | D. maculata | V. atropilosa | P. dominulus | P. aurifer |
| (E)-4,8-dimethyl- | 0.25 | 0.5 | 15 | 68 | 8 | 0 | 0 | 7 | 0 |
| 1,3,7-nonatriene | | | | | | | | | |
| (E)-4,8-dimethyl- | 0.5 | 1 | 30 | 90 | 8 | 1 | 0 | 2 | 0 |
| 1,3,7-nonatriene | | | | | | | | | |
| (E)-4,8-dimethyl- | 1 | 2 | 75 | 47 | 5 | 1 | 0 | 13 | 0 |
| 1,3,7-nonatriene | | | | | | | | | |
| (E)-4,8-dimethyl- | 1.5 | 3 | 175 | 77 | 5 | 0 | 0 | 8 | 0 |
| 1,3,7-nonatriene | | | | | | | | | |
| (E)-4,8-dimethyl- | 2 | 5.5 | 325 | 46 | 1 | 0 | 1 | 5 | 0 |
| 1,3,7-nonatriene | | | | | | | | | |
| WHY Alone | | | | 50 | 4 | 0 | 0 | 4 | 1 |
| Blank | | | | 0 | 0 | 0 | 0 | 0 | 0 |

TABLE 3
(EXPERIMENT 3)

| | 2 mL VWR Centrifuge | | | | | | | | | | Total Paper Wasps | |
|---|---|---|---|---|---|---|---|---|---|---|---|---|
| | Tube with Cotton | | | Total Yellowjackets Caught | | | | | | | Caught | |
| Treatment | Release | Hole | Loading | V. | V. | V. | D. | V. | V. | D. | P. | P. |
| Alone | Rate | Size mm | μL | atropilosa | pensylvanica | vulgaris | maculata | acadica | germanica | arenaria | dominulus | aurifer |
| Blank | 0 | | | 0 | 23 | 3 | 0 | 1 | 0 | 0 | 5 | 1 |
| (E)-4,8- | 0.25 | 0.5 | 15 | 2 | 43 | 4 | 0 | 0 | 0 | 0 | 7 | 3 |
| dimethyl-1,3,7- | | | | | | | | | | | | |
| nonatriene | | | | | | | | | | | | |
| (E)-4,8- | 0.5 | 1 | 30 | 1 | 12 | 6 | 0 | 0 | 0 | 0 | 6 | 1 |
| dimethyl-1,3,7- | | | | | | | | | | | | |
| nonatriene | | | | | | | | | | | | |
| (E)-4,8- | 1 | 2 | 75 | 0 | 34 | 4 | 0 | 0 | 0 | 0 | 4 | 0 |
| dimethyl-1,3,7- | | | | | | | | | | | | |
| nonatriene | | | | | | | | | | | | |
| (E)-4,8- | 1.5 | 3 | 175 | 0 | 24 | 2 | 0 | 0 | 0 | 0 | 17 | 5 |
| dimethyl-1,3,7- | | | | | | | | | | | | |
| nonatriene | | | | | | | | | | | | |
| (E)-4,8- | 2 | 5.5 | 325 | 1 | 24 | 5 | 0 | 0 | 0 | 0 | 10 | 0 |
| dimethyl-1,3,7- | | | | | | | | | | | | |
| nonatriene | | | | | | | | | | | | |
| WHY Alone | | | | 8 | 603 | 117 | 82 | 0 | 1 | 2 | 26 | 9 |

Statistical Analysis.

Trap catch data were converted to proportion (P) of total captured wasps within each replicate. Data were then transformed by arcsin√P to meet the assumptions of normality and homogeneity of variances for ANOVA. Means were compared by ANOVA followed by the Ryan-Einot-Gabriel-Welsh (REGW) multiple Q test (SPSS 16.0 for Windows) at α=0.05.

### Results

### GC-EAD and Chemical Identifications

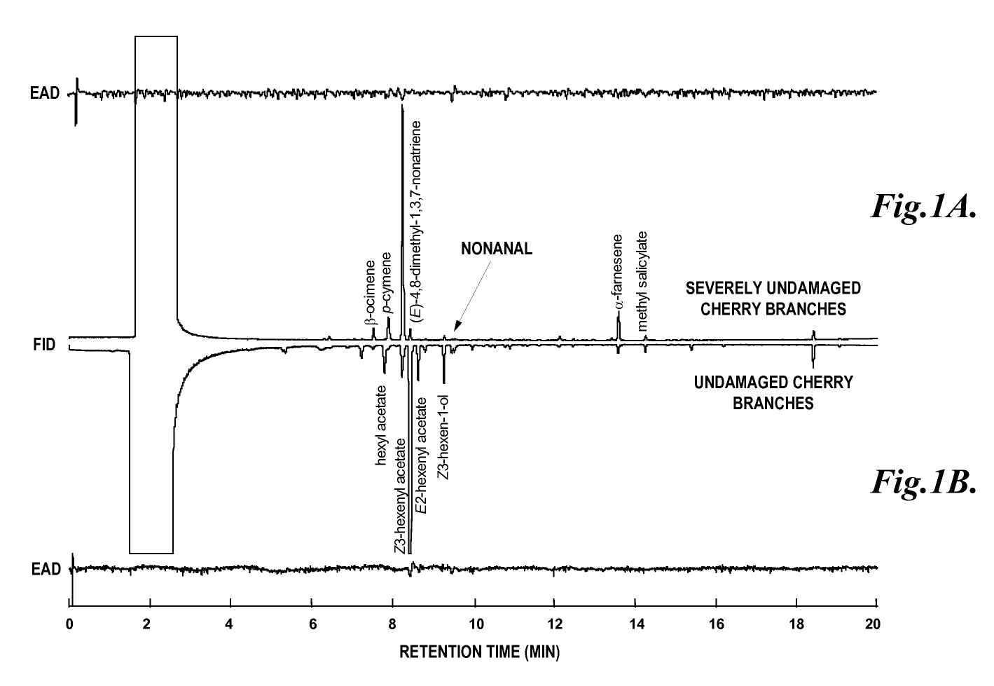

Antennae of the European paper wasp (P. dominulus) workers strongly responded to a major component and several minor components from the undamaged or slightly damaged cherry branches that were identified by GC-MS as (Z)-3-hexenyl acetate (major), and (E)-2-hexenyl acetate, (Z)-3-hexen-1-ol and nonanal (minors) (FIG. 1A). In contrast to the undamaged/slightly damaged cherry branches, the severely damaged cherry branches released a huge amount of (E)-4,8-dimethyl-1,3,7-nonatriene as the most dominant volatile component, eliciting a significant EAD response by P. dominulus worker antennae (FIG. 1B). Other minor components from the badly damaged cherry branches, such as ocimene, p-cymene, (Z)-3-hexenyl acetate, (Z)-3-hexen-1-ol, α-farnesene, and methyl salicylate, did not elicit significant EAD-responses at their current release rates; however, a repeatable antennal response to a tiny peak of nonanal was recorded (FIG. 1).

GC-EAD analysis of a synthetic mixture of known HIPVs indicated that antennae of P. dominulus workers responded consistently to most of the HIPV candidates, including β-ocimene, (Z)- and (E)-4,8-dimethyl-1,3,7-nonatriene, (Z)-3-hexenyl acetate, (Z)-3-hexen-1-ol, linalool, geranyl acetate and methyl salicylate (FIG. 2). No repeatable EAD-responses to trans-β-caryophyllene or trans-β-farnesene were obtained at the dosages tested. The major beneficial insects, Chrysopa oculata, Myrmeleon crudelis, Podisus maculiventris, and Hippodarnia convergens, also showed similar strong EAD-responses, as did the paper wasps, especially toward (E)-4,8-dimethyl-1,3,7-nonatriene, β-ocimene, (Z)-3-hexenyl acetate and methyl salicylate (FIG. 6).

### Field Trapping Experiments

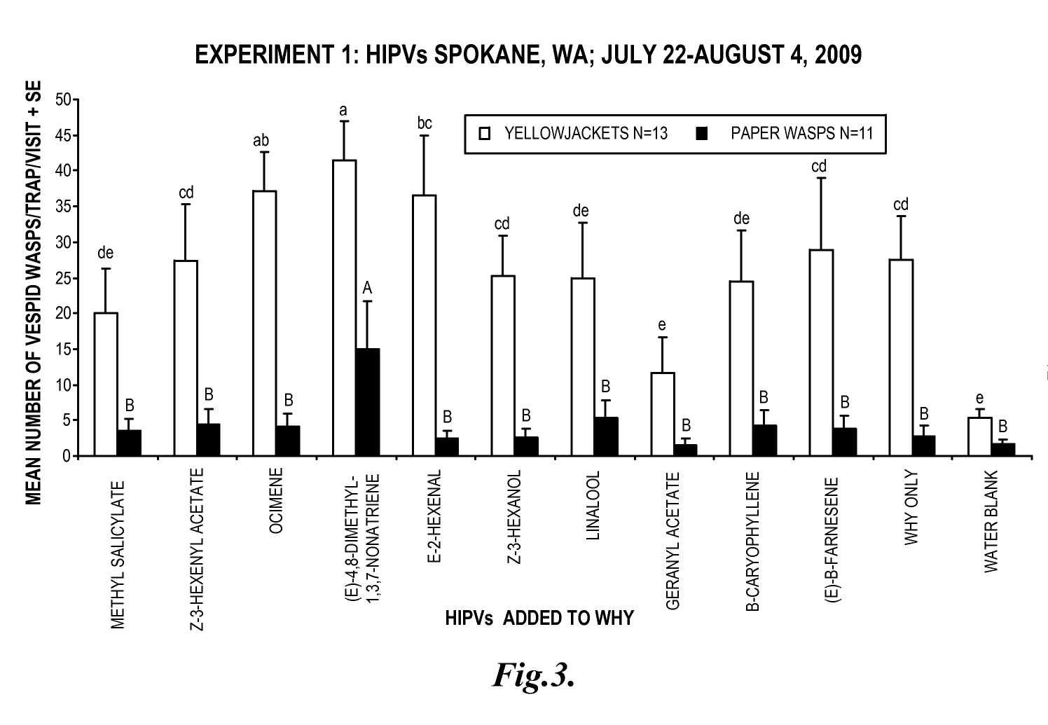

In Experiment 1, W•H•Y attractants alone caught significantly more yellowjackets (both top and bottom attractants) than did the water blank control traps (FIG. 3; Table 1). Adding the HIPVs in the trap bottom chamber containing the heptyl butyrate did not show any impact on yellowjacket catches (with a mean catch being around 15-20 workers/trap/visit). The bottom catches include mainly the V. atropilosa (59.6%) and V. pensylvanica (36%) plus a small number of V. acadica (1.4%) and V. consobrina (2.5%) and V. vulgaris (0.3%)]. However, combining (E)-4,8-dimethyl-1,3,7-nonatriene with W•H•Y attractant in the top chamber containing acetic acid and 2-methyl-1-butanol significantly increased the trap catches of both yellowjackets (V. pensylvanica, V. vulgaris, V. atropilosa, V. acadica, D. maculata and D. arenaria) and paper wasps (P. dominulus and P. aurifer) in the top chambers (FIG. 3 and Table 1). cis-Ocimene also showed significant synergistic effect on the yellowjacket attraction. Geranyl acetate, however, showed inhibitory effect on the yellowjackets (FIG. 3).

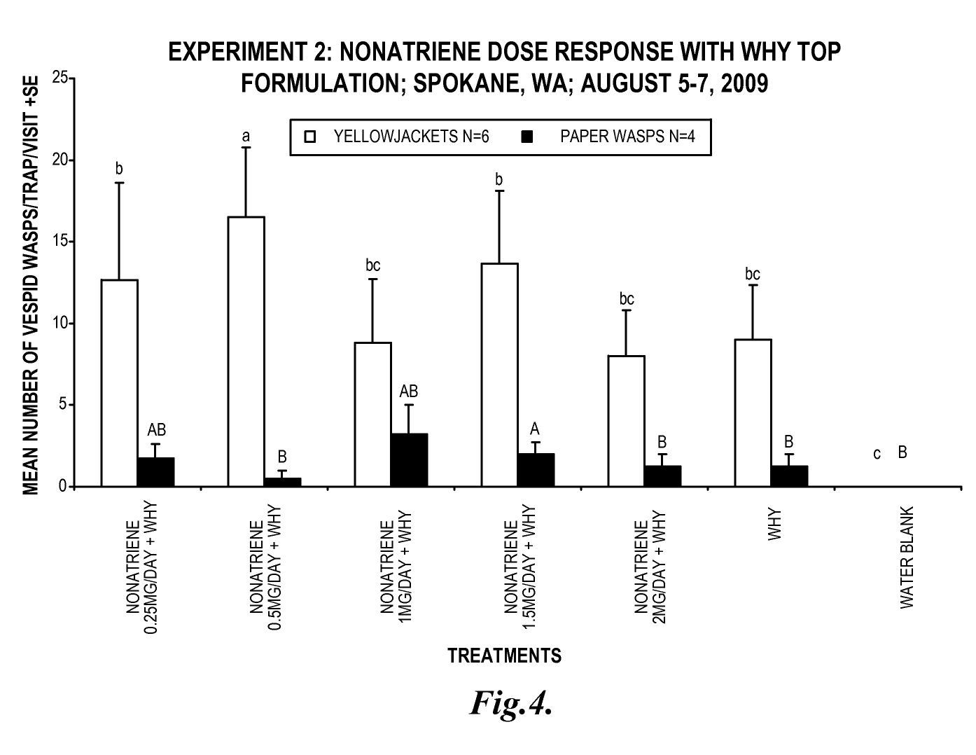

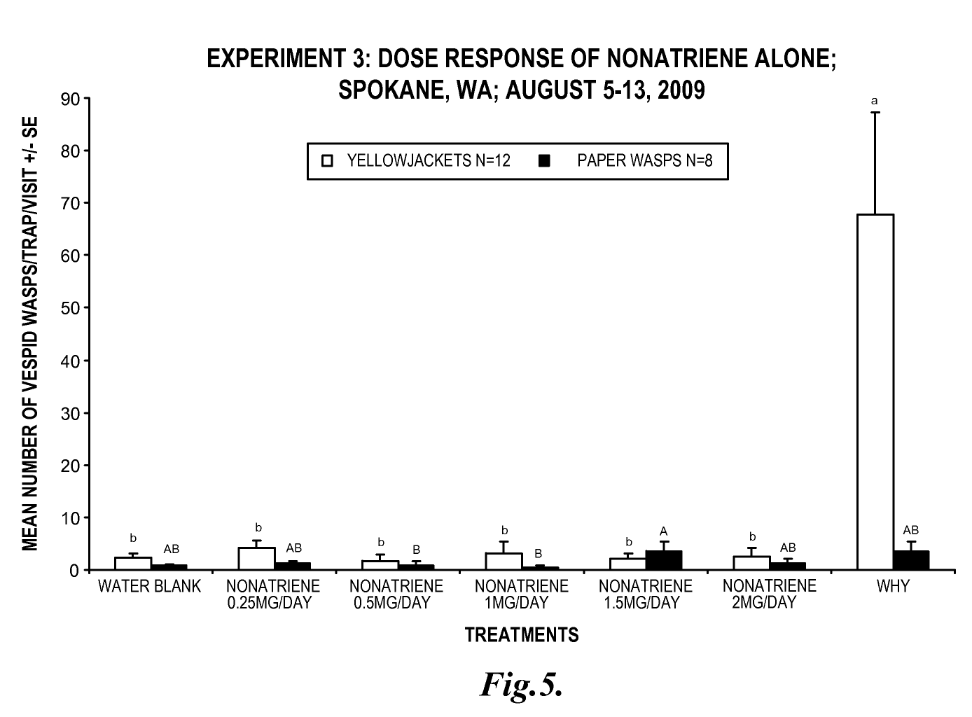

In Experiment 2, acetic acid and 2-methyl-1-butanol W•H•Y attractants (top only) alone caught significantly more paper wasps and yellowjackets than did the water blank control traps (FIG. 4; Table 2). Adding 0.5 or 1-1.5 mg/day of (E)-4,8-dimethyl-1,3,7-nonatriene to the top attractants significantly increased trap catches of the vespid workers (FIG. 4; Table 2), especially for V. pensylvanica, V. vulgaris and P. dominulus (Table 2), whereas other release rates (doses) of DMNT showed no effect on the trap catches. In Experiment 3, acetic acid and 2-methyl-1-butanol W•H•Y attractants (top chamber only) alone again caught significantly more yellowjackets than did the water blank control traps (FIG. 5); while no differences in paper wasp catches were detected due to low population level at the test site. However, W•H•Y traps baited with different doses of (E)-4,8-dimethyl-1,3,7-nonatriene alone (without any W•H•Y attractants) were not different from the water blank control traps (Table 3).

### DISCUSSION

This example shows olfactory and behavioral responses of the vespid wasps to HIPVs. GC-EAD analysis showed that the wasp and other insect antennae do have olfactory receptor neurons for detecting HIPVs, especially those released as major components from the severely damaged plants, such as cherry branches (FIG. 1). Two of the homo- and mono-terpenes, (E)-4,8-dimethyl-1,3,7-nonatriene (DMNT) and β-ocimene were shown to synergize the attraction of paper wasps and yellowjackets to the sugar-related attractants such as a mixture of acetic acid and 2-methyl-1-butanol (or its isomers) (see Tables and FIGURES). Another acrylic homoterpene, 4,8,12-trimethyl-1,3E,7E,11-tridecatetraene (TMTT), was not available for EAD and field testing; however, its strong chemical and behavioral similarities from the DMNT suggest that it may also have a great potential as a synergistic attractant for vespid wasps, especially during the early-mid summer season (live insect prey foraging season). Other HIPV candidates (especially the EAD-active ones) did not show significant synergistic effect on the mixture of AA/2MB at the doses tested; however, their combination with the active homo- or mono-terpenes may provide further synergism to the known attractants for the pestiferous vespid wasps. DMNT alone was not significantly attractive to paper wasps, yellowjackets, or hornets during the field trapping study; however, its potential positive behavioral activity at early foraging season or in combination with other HIPVs cannot be excluded.

The results clearly indicate that combining the HIPVs, especially the homo- or mono-terpenes: (E)-4,8-dimethyl-1,3,7-nonatriene (DMNT), β-ocimene or their isomers (such as trans-β-ocimene, cis-β-ocimene, trans-α-ocimene, cis-α-ocimene (chemical signals associated with foraging for live insect prey) with volatile chemicals associated with sugar-feeding (acetic acid/isobutanol or 2-methyl-1-butanol or 2-methyl-2-propanol) reveals a truly synergistic response by the foraging workers of various pestiferous yellowjacket and paper wasp species. Such behavioral synergism might be due to the significant interactions (synergism) among different olfactory receptor neurons that are responsible for perceiving/responding to various types of semiochemicals (with different functionality) at either peripheral or central nerve system level. The discovery of such synergism for vespid wasp attraction has a great practical potential in formulating better wasp lures, particularly for pestiferous wasp species during their live prey foraging period. These antennally active HIPVs may also synergize the attraction of other known attractants to the major beneficial insects such as lacewings, lady beetles, ant lions, predacious bugs, and hoverflies.

While illustrative embodiments have been illustrated and described, it will be appreciated that various changes can be made therein without departing from the spirit and scope of the invention.

The embodiments of the invention in which an exclusive property or privilege is claimed are defined as follows:

1. An insect attractant composition, comprising:
a volatile insect attractant comprising acetic acid and one or more short chain alcohols chosen from 2-methyl-1-butanol, isobutanol, and 2-methyl-2-propanol or any combination thereof; and
one or more homo- or mono-terpene herbivore-induced plant volatiles chosen from (E)-4,8-dimethyl-1,3,7-nonatriene, (Z)-4,8-dimethyl-1,3,7-nonatriene, 4,8,12-trimethyl-1,3E,7E,11-tridecatetraene, trans-β-ocimene, cis-β-ocimene, trans-α-ocimene, cis-α-ocimene, or any combination thereof.

2. The insect attractant composition of claim 1, wherein the homoterpene herbivore-induced plant volatile is (E)-4,8-dimethyl-1,3,7-nonatriene, (Z)-4,8-dimethyl-1,3,7-nonatriene or 4,8,12-trimethyl-1,3E,7E,11-tridecatetraene.

3. The insect attractant composition of claim 1, wherein the monoterpene herbivore-induced plant volatile is trans-β-ocimene, cis-β-ocimene, trans-α-ocimene or cis-α-ocimene.

4. The insect attractant composition of claim 1, wherein the volatile insect attractant chemical is 2-methyl-1-butanol, acetic acid, or a combination thereof.

5. The insect attractant composition of claim 1, wherein the homo- or mono-terpene herbivore-induced plant volatile is produced synthetically.

6. The insect attractant composition of claim 1, wherein the homo- or mono-terpene herbivore-induced plant volatile is produced from a plant.

7. The insect attractant composition of claim 1, wherein the homo- or mono-terpene herbivore-induced plant volatile is produced from cherry tree materials.

8. An insect trap, comprising the attractant composition of claim 1.

9. A method of attracting an insect, comprising:
releasing an attractant for an insect and a homo- or mono-terpene herbivore-induced plant volatile chosen from (E)-4,8-dimethyl-1,3,7-nonatriene, (Z)-4,8-dimethyl-1,3,7-nonatriene, 4,8,12-trimethyl-1,3E,7E,11-tridecatetraene, trans-β-ocimene, cis-β-ocimene, trans-α-ocimene, cis-α-ocimene, or any combination thereof; and
attracting one or more insects to the attractant and the homo- or mono-terpene herbivore-induced plant volatile.

10. The method of claim 9, further comprising attracting an eusocial insect.

11. The method of claim 9, further comprising attracting an insect from the order Hymenoptera.

12. The method of claim 11, further comprising attracting an insect from the family Vespidae.

13. The method of claim 11, further comprising attracting an insect from the subfamilies of Polistinae or Vespinae.

14. The method of claim 11, further comprising attracting an insect that is a wasp, hornet, or yellowjacket.

15. The method of claim 9, further comprising attracting an insect from the order Neuroptera.

16. The method of claim 15, further comprising attracting an insect from the family Chrysopidae.

17. The method of claim 16, further comprising attracting a green lacewing.

18. The method of claim 15, further comprising attracting an insect from the family Hermerobiidae.

19. The method of claim 18, further comprising attracting a brown lacewing.

20. The method of claim 15, further comprising attracting an insect from the family Myrmeleonitidae.

21. The method of claim 20, further comprising attracting an ant lion.

22. The method of claim 9, further comprising attracting an insect from the order Coleoptera.

23. The method of claim 22, further comprising attracting an insect from the family Coccinellidae.

24. The method of claim 23, further comprising attracting a lady beetle.

25. The method of claim 9, further comprising attracting an insect from the order Heteroptera.

26. The method of claim 25, further comprising attracting an insect from the family Pentatomidae.

27. The method of claim 26, further comprising attracting a spined soldier bug.

28. The method of claim 9, further comprising attracting an insect from the order Diptera.

29. The method of claim 28, further comprising attracting an insect from the family Syrphidae.

30. The method of claim 29, further comprising attracting a hover fly.

31. The method of claim 9, wherein the attractant is derived from a sugar.

32. The method of claim 9, further comprising placing the attractant and the homo- or mono-terpene herbivore-induced plant volatile within a trap and attracting an insect to the inside of the trap.

33. The method of claim 9, wherein the homoterpene herbivore-induced plant volatile is (E)-4,8-dimethyl-1,3,7-nonatriene, (Z)-4,8-dimethyl-1,3,7-nonatriene, 4,8,12-trimethyl-1,3E,7E,11-tridecatetraene, or a combination thereof.

34. The method of claim 9, wherein the monoterpene herbivore-induced plant volatile is trans-β-ocimene, cis-β-ocimene, trans-α-ocimene, or cis-α-ocimene.

35. The method of claim 9, wherein the attractant is acetic acid.

36. The method of claim 9, wherein the attractant is 2-methyl-1-butanol.

37. The method of claim 9, wherein the attractant is isobutanol or 2-methyl-2-propanol.

38. The method of claim 9, wherein the homo- or mono-terpene herbivore-induced plant volatile is produced synthetically.

39. The method of claim 9, wherein the homo- or mono-terpene herbivore-induced plant volatile is produced from a plant.

40. The method of claim 9, wherein the insect is any one of the species Vespula pensylvanica, Vespula vulgaris, Vespula germanica, Vespula maculifrons, Vespula sqamosa, Vespula atropilosa, Vespula acadica, Vespula consobrina, Vespula vidua, Dolichovespula maculata, Dolichovespula arenaria, Vespa crabo, Polistes dominulus, Polistes aurifer, Polistes fuscatus, Polistes metricus, Polistes carolina, Polistes perplexus, Chrysopa oculata, Myrmeleon crudelis, Podisus maculiventris, or Hippodamia convergens.

41. The method of claim 9, wherein the insect is any one of a western yellowjacket, German wasp, common wasp, Eastern yellowjacket, Southern yellowjacket, bald-faced hornet, aerial yellowjacket, prairie yellowjacket, forest yellowjacket, blackjacket, Northeastern yellowjacket, European hornet, European paper wasp, golden paper wasp, paper wasp, red wasp, green lacewing, ant lion, spined soldier bug, or lady beetle.

42. An insect attractant composition, consisting essentially of:
a volatile insect attractant chemical blend comprising acetic acid and one or more compounds chosen from 2-methyl-1-butanol, isobutanol, and 2-methyl-2-propanol, or a combination thereof; and
one or more homo- or mono-terpene herbivore-induced plant volatiles chosen from (E)-4,8-dimethyl-1,3,7-nonatriene, (Z)-4,8-dimethyl-1,3,7-nonatriene, 4,8,12-trimethyl-1,3E,7E,11-tridecatetraene, trans-β-ocimene, cis-β-ocimene, trans-α-ocimene, cis-α-ocimene, or a combination thereof, wherein there are no additional attractants in the composition.

43. An insect attractant composition, consisting of:
water;
acetic acid;
one or more attractant compounds chosen from 2-methyl-1-butanol, isobutanol, and 2-methyl-2-propanol, or a combination thereof; and
one or more homo- or mono-terpene herbivore-induced plant volatiles chosen from (E)-4,8-dimethyl-1,3,7-nonatriene, (Z)-4,8-dimethyl-1,3,7-nonatriene, 4,8,12-trimethyl-1,3E,7E,11-tridecatetraene, trans-β-ocimene, cis-β-ocimene, trans-α-ocimene, cis-α-ocimene, or a combination thereof.
